(19) United States
(12) Patent Application Publication
(10) Pub. No.: US 2009/0079862 A1
(43) Pub. Date: Mar. 26, 2009

(54) Method and apparatus providing imaging auto-focus utilizing absolute blur value

(75) Inventor: Igor Subbotin, South Pasadena, CA (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/902,748

(22) Filed: Sep. 25, 2007

(51) Int. Cl. H04N 5/232; G06K 9/40; H04N 5/335

(52) U.S. Cl. 348/345; 348/294; 382/255; 348/E05.042

(57) ABSTRACT

A method and apparatus for determining the need for and performing a refocusing of an imaging device using a blur value, which determines absolute sharpness. The blur detection is itself based on reading one or more edges. New lens positioning is controlled based on the blur value.

### FIELD OF THE INVENTION

Embodiments of the invention relate to imaging device focusing, and more particularly to systems and methods for determining whether focusing is needed during image capture.

### BACKGROUND

Solid state imaging devices, including charge coupled devices (CCD), complementary metal oxide semiconductor (CMOS) imaging devices, and others, have been used in photo-imaging applications. A solid state imaging device circuit includes a focal plane array of pixel cells, or pixels, as an image sensor, each pixel includes a photosensor, which may be a photogate, photoconductor, a photodiode, or other photosensor having a doped region for accumulating photo-generated charge. For CMOS imaging devices, each pixel has a charge storage region, formed over or in the substrate, which is connected to the gate of an output transistor that is part of a readout circuit. The charge storage region may be constructed as a floating diffusion region. In some CMOS imaging devices, each pixel may further include at least one electronic device such as a transistor for transferring charge from the photosensor to the storage region and one device, also typically a transistor, for resetting the storage region to a predetermined charge level prior to charge transference. CMOS imaging devices of the type discussed above are discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, each assigned to Micron Technology, Inc.

Imaging devices are typically incorporated into a larger device, such as a digital camera or other imaging apparatus, which would also include a lens or a series of lenses that focus light onto an array of pixels that, in operation with memory circuitry, records an image electronically.

The relative distance between the lens or system of lenses and an imaging device is typically adjustable so that the image captured by the pixel array can be focused and in most devices this focusing is accomplished by auto-focus using the processor of the device, e.g., a digital camera, to control the lens movement. Broadly explained, an auto-focus processor in a digital camera looks at a group of imaged pixels and looks at the difference in intensity among the adjacent pixels. If an imaged scene is out of focus, adjacent pixels at an edge present in an image have similar or gradually changing intensities. The processor moves the lens, looks at the group of pixels again and determines whether the difference in intensity between adjacent pixels at the edge improves or worsens. The processor then searches for the point where there is maximum intensity difference between adjacent pixels, i.e., the sharpest edge, which is the point of best focus.

Holding a moving object in focus is difficult, especially without subsidiary equipment, because the decision to refocus has to be made based on information received from frame statistics only. The standard approach is to refocus the scene each time motion in the scene is detected. Such a method, however, tends to refocus a scene even when the object remains in focus. Sharpness filters have been employed to improve focusing. Some edge-detection systems are based upon the first derivative of the intensity, or value, of points of image capture. The first derivative gives the intensity gradient of the image intensity data received and output by the pixels. Using Equation 1, set forth below, where I(x) is the intensity of pixel x, and I′(x) is the first derivative (intensity gradient or slope) at pixel x, it can be resolved that:

I′(x)=−1/2·I(x−1)+0·I(x)+1/2·I(x+1) Eq. 1

A Sobel filter, which calculates the gradient of the image intensity at each point, giving the direction of the largest possible increase from light to dark and the rate of change (i.e., slope of value) in that direction, has been employed to determine imaging focusing needs. The Sobel filter result shows how abruptly the image changes at a point on the pixel array, and therefore how likely it is that that part of the respective image represents an edge, as well as how that edge is likely to be oriented. The steepness or flatness of the value change slope at an edge provides a sharpness score per the Sobel filter such that a flatter slope means a blurrier image because the edge is not as abrupt as one having a steeper sloped edge. The Sobel filter represents a rather inaccurate approximation of the image gradient, but is still of sufficient quality to be of practical use in many applications. More precisely, it uses intensity values only in a 3×3 region around each image point to approximate the corresponding image gradient, and it uses only integer values for the coefficients, which weigh the image intensities to produce the gradient approximation. This calculation can be used to determine whether refocusing is needed.

While useful, the Sobel filter has drawbacks. A gradual change in value over a great number of pixels, representing an actual blurry image, would have the same sharpness score as a same change in value over a small number of pixels, which would relate to a relatively sharper image. Furthermore, a Sobel filter can make other mistakes in interpreting blurriness when a relatively higher contrast and magnitude value change (represented by a relatively steep slope with highly divergent end points) is compared to a relatively lower contrast and magnitude value change (represented by a flatter slope with less divergent end points) over the same number of pixels. A Sobel filter would mistakenly interpret two different sharpness scores for such images, even though it is possible that both edges are similarly blurred. Accordingly, there is a need and desire for a better auto-focusing technique.

### BRIEF DESCRIPTION OF THE DRAWINGS

FIG. 1 shows an imaging device pixel array with an image focused thereon.

FIG. 2a shows a pixel window of the imaging device pixel array shown in FIG. 1; FIG. 2b shows a representation of pixels of the window of FIG. 2a and the value change of the image portions captured.

FIG. 3 is a flowchart illustrating a method for determining image sharpness and need for focusing for single frame imaging.

FIG. 4 illustrates value changes of edges as such relates to blur value.

FIG. 5 is and example of a blur magnitude histogram.

FIG. 6 is a flowchart illustrating a method for determining image sharpness and need for focusing for continuous imaging.

FIG. 7 shows an imaging device in accordance with the disclosed embodiments.

FIG. 8 shows a camera system, which employs an imaging device and processor in accordance with the disclosed embodiments.

### DETAILED DESCRIPTION

In the following detailed description, reference is made to the accompanying drawings which form a part hereof, and in which is shown by way of illustration specific embodiments that may be practiced. These embodiments are described in sufficient detail to enable those of ordinary skill in the art to make and use them, and it is to be understood that structural, logical, or procedural changes may be made to the specific embodiments disclosed without departing from the spirit or scope of the invention.

The methods, devices and systems disclosed herein provide image sharpness detection and enable controlling of imager device auto-focusing in response to detected blur. The image capture can be for still image or continuous image, i.e., video, capture. The disclosed embodiments, optionally using a relatively small, e.g., 9×9, pixel window, base sharpness detection on a blur value relating to the number of pixels in rows or columns of the pixel window reading a perceived edge in the associated portion of a captured image. The blur value does not depend on edge(s) intensity, but rather, defines an absolute image sharpness.

Sharpness is compared from one focus (during auto-focusing) to another in still imaging and from one focused frame to another (or during detected motion) in continuous image (i.e., video) capture. The larger the blur value, the less focused the image is as a whole. As opposed to the Sobel filter, the blur value further calculates blur from the slope and height of value change at points in the image. The auto-focus of the imaging device is controlled, at least in part, by a processor based on the blur value score. The methods disclosed herein can be implemented as software instructions for a processor, as hardwired logic circuits, or as a combination of the two. This process is further described below with reference to the figures, in which like reference numbers denote like features.

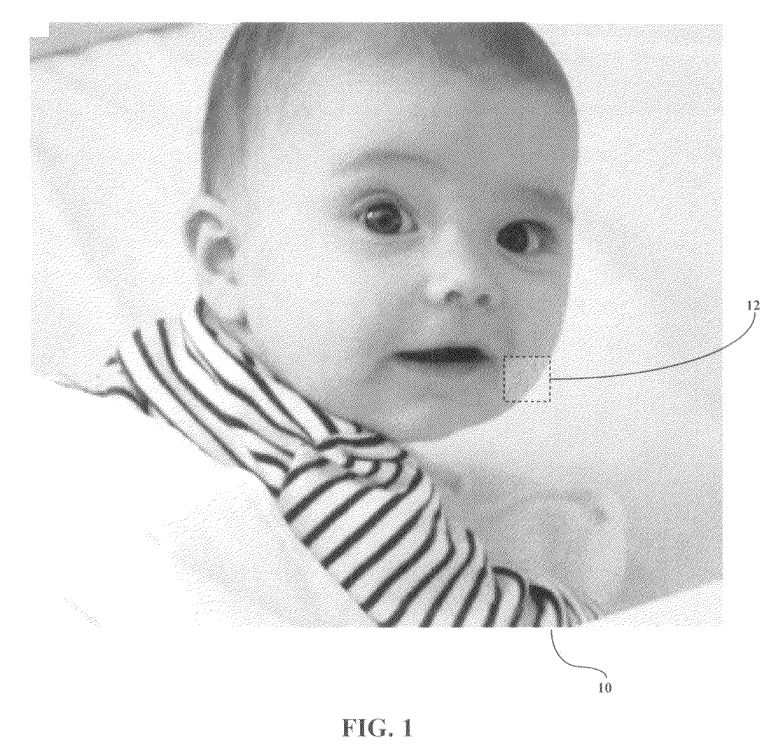

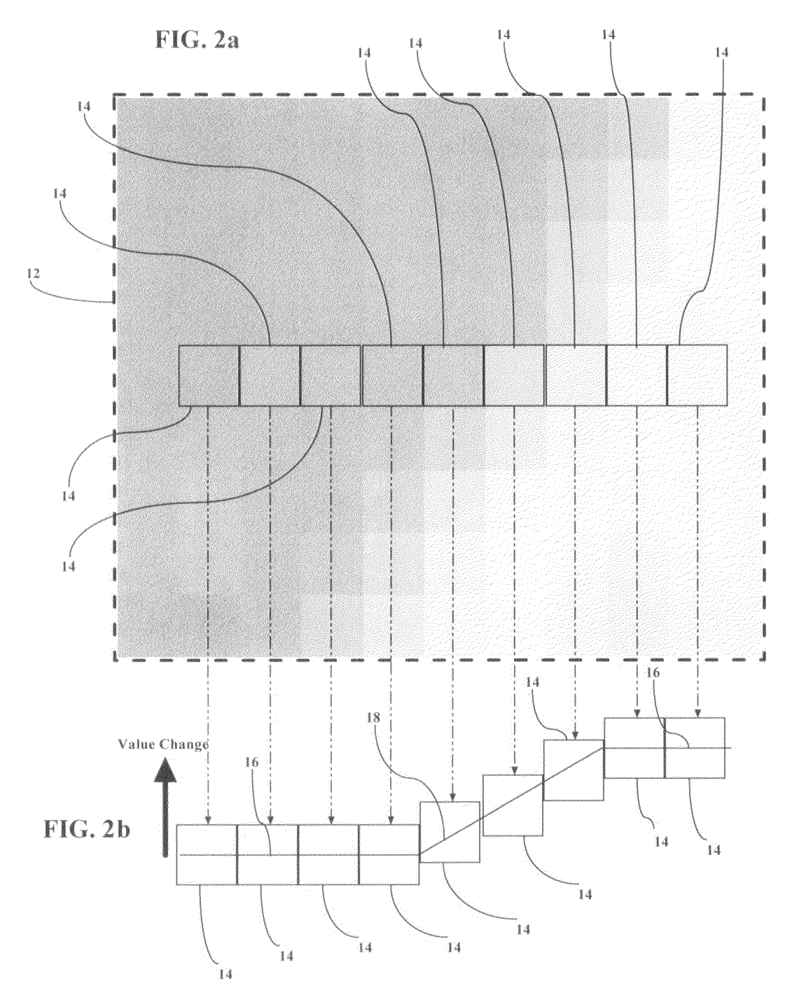

FIG. 1 shows an imaging device pixel array 10 consisting of a plurality, e.g., millions in a megapixel device, of pixels capturing an image. Optionally, one or more relatively small windows 12 of pixels is defined to survey and thereby determine if there are edges in the captured image. The pixel window 12 can be, for example, a 9×9 block of pixels. The pixel window 12 need not be a fixed group of pixels 14 (FIG. 2a), but can be shifted to various locations on the pixel array 10. Likewise, any number of pixels 14 (FIG. 2a) can be included in the window 12. A blur value is calculated for the captured image based on the edges perceived in the pixel window 12.

FIG. 2a shows the pixel window 12 of FIG. 1 in greater detail and generally shows the location of the pixels 14. In this embodiment, there are 9 pixels 14 per row across the pixel window 12 (as well as 9 pixels per column in the pixel window 12) and a change in captured image value can be seen running diagonally across the pixel window 12. This change in value is an edge and is roughly represented for this row of pixels 14 in FIG. 2b by the positioning of the pixels 14 along a line showing value change. As shown in FIG. 2b, there are groups of pixels 14 that read relatively constant value, represented by the flat lines 16. Between these groups of pixels 14 is another group of pixels 14 registering a value change, represented by the line 18. The slope of line 18 represents the value change across these pixels 14. The number of pixels 14 of the row shown in FIGS. 2a and 2b registering this changing value 18 represent the edge, and once the slope and magnitude of the value change is determined, the blur value can be calculated. When the blur value is determined for all of the image points surveyed and averaged, an absolute sharpness can be determined for the total captured image, which can be used by an auto-focus processor of a device, e.g., a digital camera, to refocus the image on the array 10.

A technique for defining blur value can use a first derivative filer (e.g., (1,−1); (1,2,1,0,−1,−2,−1) . . . ) to obtain the slope for the edge at a current point, e.g., a pixel 14, in the image, preferably using a pixel window 12 so as not to survey every pixel 14 of an array 10. The slope is equivalent to an intensity gradient at a point in the image, and can be determined by vector calculus and differential geometry using the gradient operator ∇ where ∇ is determined by Equation 2 as follows:

$$∇ = [ \begin{matrix}\frac{ϑ}{ϑ x} \\ \frac{ϑ}{ϑ y}\end{matrix} ] \qquad Eq . 2$$

Applying this vector operator to a function, Equation 3, as follows can be used to compute the magnitude and orientation of the gradient, i.e., slope:

$$∇ \int = [ \begin{matrix}\frac{ϑ}{ϑ x} \int \\ \frac{ϑ}{ϑ y} \int \end{matrix} ] \qquad Eq . 3$$

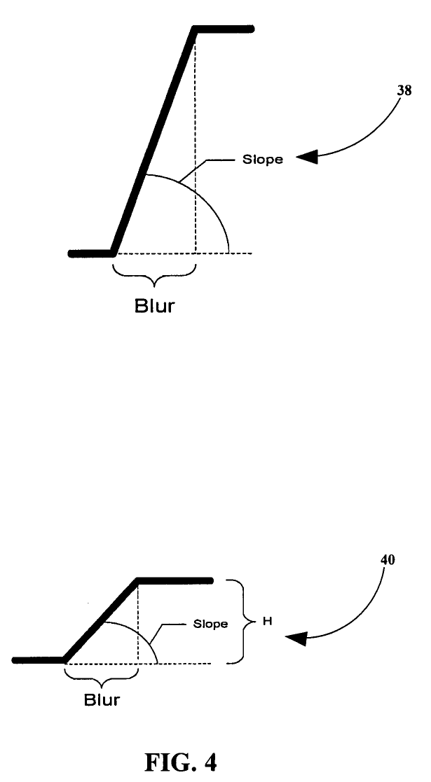

The magnitude ∥∇ƒ∥ and orientation φ(∇ƒ) can be calculated, as with any vector, which provides the value change slope a the edge. Next, the minimum (min) and maximum (max) pixel 14 signal around the current point, which, depending on optics, pixel size, and other parameters, can be a single pixel 14, are determined and are then subtracted to get the edge height (H) (FIG. 4), using Equation 4 as follows:

H=max−min Eq. 4

The blur value (BLUR) at that point is then identified by dividing the height H by the slope, as shown in Equation 5 as follows:

BLUR=H/slope Eq. 5

This process can be repeated for each point being surveyed, for example, for each pixel 14 of the pixel window 12 or each pixel of the array 10, as desired, depending on what part of the image the auto-focus method works with. The average BLUR for the points surveyed, e.g., pixels 14, provides an absolute sharpness for the image.

The blur value is not limited to sampling images in the pixel window 12 using pixels 14 arranged in horizontal rows as shown in FIG. 2a, but columns of vertically arranged pixels 14 or even non-vertical and non-horizontal lines of pixels 14 may be used also. A blur value can be obtained for each pixel 14 of the pixel window 12. The blur value will be higher for less focused images.

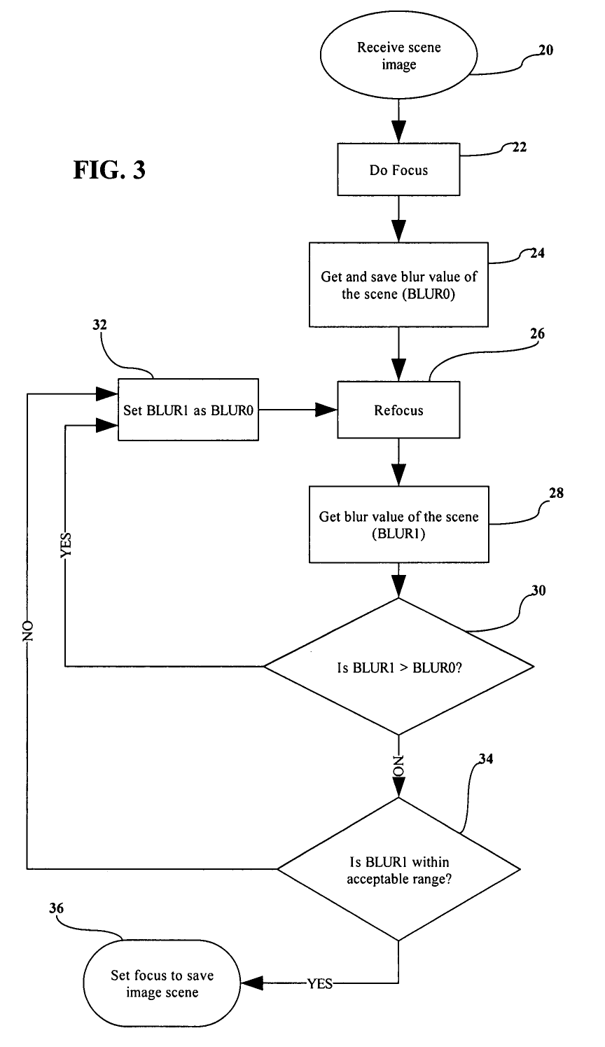

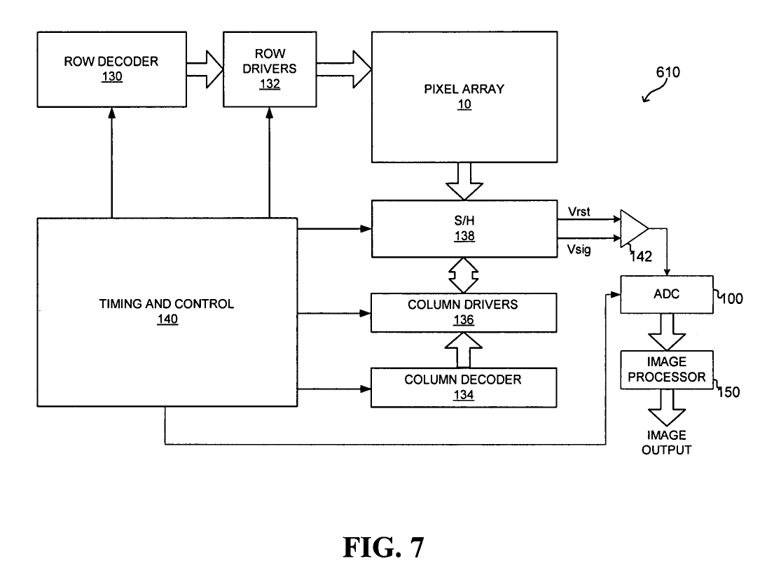

FIG. 3 shows a flowchart illustrating how the blur value can be used in auto-focusing for an imaging device according to an embodiment. At step 20, the imaging device receives an image, which is captured by the pixel array 10 (FIG. 1). The image is focused on the pixel array 10 at step 22 by a lens or series of lenses 638 (FIG. 7). At step 24, a first blur value (BLUR0) is obtained for the captured image, as discussed above. At step 26 the image is refocused on the pixel array 10 by adjusting the lens 638 (FIG. 7) and/or adjusting the pixel array 10 with respect to the lens 638.

A second blur value (BLUR1) is obtained for this refocused image. At step 30, if BLUR1 is greater than BLUR0, this means the image is less focused than before, BLUR 1 is set to be the new BLUR0 (step 32) the image is again refocused (step 26) and the blur value recalculated as a new BLUR1 (step 28). At step 30, if BLUR1 is not greater than BLUR0, meaning that the image is sharper and more focused after the refocus step 26, the process moves on to step 34 where it is determined whether BLUR1 is within an acceptable range so that the image can be considered properly focused. If it is determined that BLUR1 is acceptable, the auto-focus operation is complete and the focus is set to save the captured image at step 36; alternatively, the focus can be set for a next image capture operation. If BLUR1 is not acceptable, the process returns to step 32 where BLUR1 is set to be BLUR0, the image is refocused on the pixel array 10 by returning to step 26 and thereafter the blur value is recalculated.

Use of the blur value rather than using the signal slope of the edge as with a Sobel filter eliminates dependency on edge intensity. FIG. 4 shows two possible edges like those shown in FIG. 2b. Edge 38 is a high intensity edge with relatively greater change in value over a given number of pixels 14 while edge 40 is a lower intensity edge with less change in value over the same number of pixels 14. Because the blur value of the embodiments disclosed herein defines an absolute image sharpness, the process of these embodiments would recognize both edges 38 and 40 as blurred and would refocus accordingly.

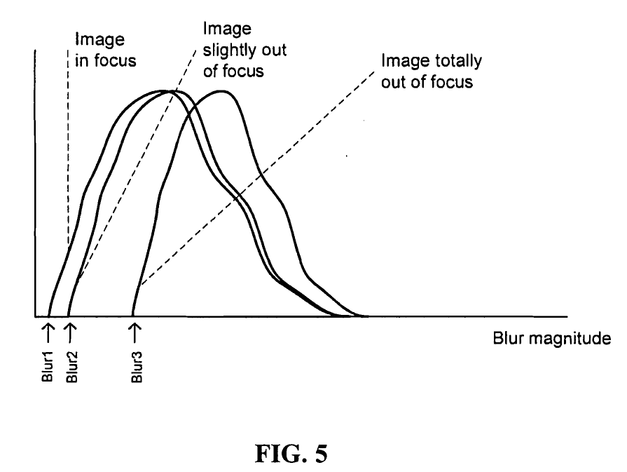

In any captured image there can be different types of edges: sharp (e.g., 1-2 pixels 14 in best focus) and wide edges. To avoid the effect of wide edges on average blur value, a blur magnitude histogram as shown in FIG. 5 can be used to identify low range of blur magnitude distribution for image sharpness criteria. As shown in FIG. 5, different image focus provides different blur magnitudes. The values Blur1, Blur2, and Blur3 of the FIG. 5 histogram do not depend on the particular image and can be used as image sharpness criteria. Use of such a histogram mitigates noise interference on the blur value results; the histogram is built for edges greatly exceeding the noise level only. For the algorithm defining blur value, described above, the histogram can be incorporated using Equation 6, as follows:

H=max−min>H_{—}th Eq. 6

where H_th is a programmable threshold depending on noise level. Thus, if the difference in minimum and maximum signals is merely due to normal noise, the height H will be less than H_th, meaning that no re-focus is necessary. If H is greater than H_th, then the difference in minimum and maximum signals is due to blurriness and the image can be re-focused.

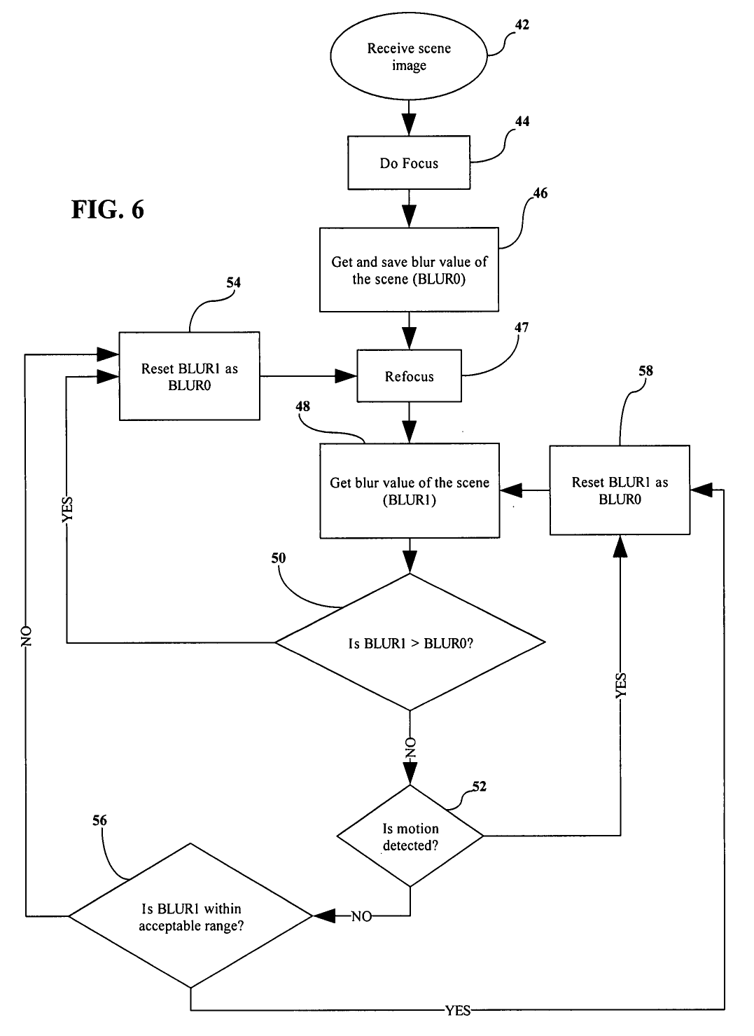

FIG. 6 shows a flowchart illustrating how the blur value can be used in auto-focusing for an imaging device according to another embodiment where continuous image capture is desired, for example in video capture. At step 42 an image is received on the pixel array 10. The image is then focused at step 44. At step 46 the blur value (BLUR0) is obtained. Next at step 47, the image is refocused and at step 48 a blur value (BLUR1) is obtained.

BLUR1 is next compared to BLUR0 at step 50. If BLUR1 is greater than BLUR0, indicating a less focused image than before, BLUR1 is set to be BLUR0 at step 54 and the image is refocused at step 47. If at step 50 BLUR1 was not greater than BLUR0, the process progresses to step 52 to determine if motion is detected. Motion may be detected by known methods, or for example, by using techniques or methods such as those disclosed in U.S. patent application Ser. No. 11/802,728, assigned to Micron Technology, Inc. If motion is detected, the process continues to step 58 to look for motion. If motion is not detected, the process proceeds to step 56 where it is determined whether the blur value (BLUR1) is within an acceptable range for a focused image. If it is determined that BLUR1 is acceptable, BLUR1 is reset as BLUR0 and the process returns to step 48 to obtain a BLUR1 value. If at step 56 BLUR 1 is not acceptable, BLUR1 is reset to BLUR0 at step 54 before returning to step 47.

FIG. 7 illustrates a block diagram for a CMOS imager 610 in accordance with the embodiments described above. The imager 610 includes a pixel array 10. The pixel array 10 comprises a plurality of pixels arranged in a predetermined number of columns and rows. The pixels of each row in array 10 are all turned on at the same time by a row select line and the pixel signals of each column are selectively output onto output lines by a column select line. A plurality of row and column select lines are provided for the entire array 10.

The row lines are selectively activated by the row driver 132 in response to row address decoder 130 and the column select lines are selectively activated by the column driver 136 in response to column address decoder 134. Thus, a row and column address is provided for each pixel. The CMOS imager 610 is operated by the control circuit 40, which controls address decoders 130, 134 for selecting the appropriate row and column select lines for pixel readout, and row and column driver circuitry 132, 136, which apply driving voltage to the drive transistors of the selected row and column select lines.

Each column contains sampling capacitors and switches 138 associated with the column driver 136 that reads a pixel reset signal Vᵣₛₜ and a pixel image signal V_{sig} for selected pixels. A differential signal (e.g., Vᵣₛₜ−V_{sig}) is produced by differential amplifier 140 for each pixel and is digitized by analog-to-digital converter 100 (ADC). The analog-to-digital converter 100 supplies the digitized pixel signals to an image processor 150, which forms a digital image output.

The signals output from the pixels of the array 10 are analog voltages. These signals must be converted from analog to digital for further processing. Thus, the pixel output signals are sent to the analog-to-digital converter 100. In a column parallel readout architecture, each column is connected to its own respective analog-to-digital converter 100 (although only one is shown in FIG. 7 for convenience purposes).

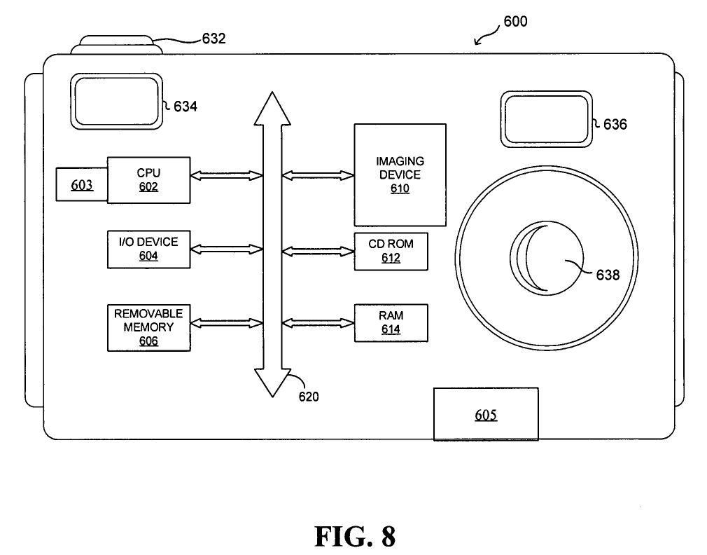

Disclosed embodiments may be implemented as part of a camera such as e.g., a digital still or video camera, or other image acquisition system. FIG. 8 illustrates a processor system as part of, for example, a digital still or video camera system 600 employing an imaging device 610 (FIG. 7), which can have a pixel array 10 as shown in FIG. 1, and processor 602, which provides focusing commands using blur value in accordance with the embodiments shown in FIGS. 3 and 6 and described above. The system processor 602 (shown as a CPU) implements system, e.g. camera 600, functions and also controls image flow through the system. The sharpness detection methods described above can be provided as software or logic hardware and may be implemented within the image processor 150 of the imaging device 610, which provides blur scores to processor 602 for auto-focus operation. Alternatively, the methods described can be implemented within processor 602, which receives image information from image processor 150, performs the blur score calculations and provides control signals for an auto-focus operation.

The processor 602 is coupled with other elements of the system, including random access memory 614, removable memory 606 such as a flash or disc memory, one or more input/out devices 604 for entering data or displaying data and/or images and imaging device 610 through bus 620 which may be one or more busses or bridges linking the processor system components. The imaging device 610 receives light corresponding to a captured image through lens 638 when a shutter release button 632 is depressed. The lens 638 and/or imaging device 610 pixel array 10 are mechanically movable with respect to one another and the image focus on the imaging device 610 can be controlled by the processor 602 in accordance with the embodiments described herein. In one embodiment, the lens 638 is moved and in an alternative embodiment, the imaging device 610 is moved. As noted, the blur value can be calculated by an image processor 150 within image device 610 or by processor 602, the latter of which uses the blur value to directly control an auto-focus operation within camera 600, alternatively, processor 602 can provide the blur value or control commands to an auto-focus processor 605 within the camera 600. The auto-focus processor 605 can control the respective movements of the imaging device 610 and lens 636 by mechanical devices, e.g., piezoelectric elements(s).

The camera system 600 may also include a viewfinder 636 and flash 634, if desired. Furthermore, the camera system 600 may be incorporated into another device, such as a mobile telephone, handheld computer, or other device.

The above description and drawings should only be considered illustrative of example embodiments that achieve the features and advantages described herein. Modification and substitutions to specific process conditions and structures can be made. Accordingly, the claimed invention is not to be considered as being limited by the foregoing description and drawings, but is only limited by the scope of the appended claims.

What is claimed as new and desired to be protected by Letters Patent of the United States is:

1. A method for controlling the focus of an imaging device, comprising:
receiving an image on a pixel array;
determining an edge slope for a current point in the received image;
calculating a difference in a minimum and a maximum signal around the current point, the difference being a height;
dividing the height by the edge slope to define a blur value; and
using the blur value to control focus of the imaging device.

2. The method of claim 1, comprising:
defining a respective blur value for a plurality of additional points; and
calculating an average blur value based on each defined blur value.

3. The method of claim 1, wherein the current point is in a window of pixels, wherein the window encompasses and area of the pixel array less than the full size of the pixel array.

4. The method of claim 3, wherein the pixel window comprises a 9×9 group of pixels.

5. The method of claim 1, further comprising defining blur value for a still image capture.

6. The method of claim 1, further comprising defining blur value for continuous image capture.

7. A method of auto-focusing an imaging device, comprising:
focusing an image on a pixel array;
determining a first blur value for the image;
refocusing the image on the pixel array;
determining a second blur value for the image; and
repeatedly refocusing and determining additional blur values until the blur value is determined to be within a predetermined range.

8. The method of claim 7, further comprising comparing the second blur value to the first blur value, wherein if the second blur value is greater than the first blur value, a second refocus is performed.

9. The method of claim 7, wherein the acceptability of the focus is not determined until the second blur value is not greater than the first blur value.

10. The method of claim 7, wherein the second blur value is set to be the first blur value each time a refocus is performed.

11. A method of controlling a continuous auto-focus operation, comprising:
focusing an image on a pixel array;
determining a first blur value for the image;
refocusing the image on the pixel array;
determining a second blur value for the image;
comparing the second blur value to the first blur value;
setting the second blur value to be a new first blur value;
determining if motion is detected; and
if motion is detected, determining a third blur value for the image.

12. The method of claim 11, comprising refocusing if the second blur value is greater than the first blur value.

13. The method of claim 11, comprising determining if the second blur value relates to a focused image if the second blur value is not greater than the first blur value.

14. An imaging device, comprising:
a pixel array;
at least one lens;
a device providing relative movement between the lens and the pixel array for focusing an image passing through the lens on the pixel array; and
a circuit configured to determine the sharpness of the image focused on the pixel array by calculating edge height at a point of the pixel array and dividing by edge slope at the point.

15. The imaging device of claim 14, wherein the circuit configuration is provided as software instructions executed by a processor.

16. The imaging device of claim 14, wherein the circuit configuration is provided as a logic circuit.

17. The imaging device of claim 14, wherein the circuit at least partially controls the means for focusing.

18. An imaging device, comprising:
a pixel array;
a lens positioned to focus an image on the pixel array;
a first device configured to determine blur value of an image focused on the pixel array by determining the edge height at a point on the pixel array and dividing by the edge slope at the point; and
a second device configured to refocus the image on the pixel array based on the blur value.

19. The imaging device of claim 18, wherein the first device is a processor programmed with software.

20. The imaging device of claim 18, wherein the first device is a hardwired logic circuit.

21. The imaging device of claim 18, wherein the second device controls movement of the lens.

22. The imaging device of claim 18, wherein the second device controls movement of the pixel array.

23. The imaging device of claim 24, wherein the imaging device is part of a still camera.

24. The imaging device of claim 24, wherein the imaging device is part of a video camera.
